(19) United States
(12) Patent Application Publication
(10) Pub. No.: US 2016/0242026 A1
(43) Pub. Date: Aug. 18, 2016

(54) Mobility management method, device, system and computer storage medium

(71) Applicant: ZTE CORPORATION, Guangdong (CN)

(72) Inventors: Aifang Sun, Shenzhen (CN); Jianfu Cao, Shenzhen (CN); Zhihao Ling, Shenzhen (CN); Zhifei Zhang, Shenzhen (CN); Chong Gao, Shenzhen (CN); Xuewen Qi, Shenzhen (CN); Jian Bao, Shenzhen (CN)

(73) Assignee: ZTE Corporation, Shenzhen, GD (CN)

(21) Appl. No.: 15/023,927

(22) PCT Filed: Feb. 21, 2014
(86) PCT No.: PCT/CN2014/072406

§ 371 Date: Mar. 22, 2016

(30) Foreign Application Priority Data
Sep. 22, 2013 (CN) 201310438094.6

(51) Int. Cl. H04W 8/30; H04W 8/02; H04W 8/22; H04W 4/08

(52) U.S. Cl. CPC H04W 8/30; H04W 4/08; H04W 8/02; H04W 8/22

(57) ABSTRACT

Disclosed in the embodiments of the present invention are a method, device and system for mobility management as well as a computer storage medium. The method comprises: reception by an MME of a service command and extraction from same of service information; determining on the basis of said information which wireless networks are accessed by each terminal of a terminal cluster; invoking, on the basis of the wireless network accessed by each terminal of a terminal cluster, the service requested by each such terminal of a terminal cluster.

### TECHNICAL FIELD

The disclosure relates to a network management technology, and in particular to a mobility management method, device and system and a computer storage medium.

### BACKGROUND

With development of a network communication technology and continuous improvement of terminal manufacturing level, service experience requirements of users become broader and broader. Under a ubiquitous network condition, there may exist different terminal equipment around a user, and invoking different terminal equipment to cooperatively provide various kinds of required services for the user according to characteristics of the services and a personalized requirement of the user may effectively break a capability constraint of a single terminal and improve service experiences of the user.

In a conventional art, a mobility management technology for a terminal group mainly implements management over the terminal group from a network side, and terminals in the group are managed in a manner of arranging a manager or a management server on the network side. When the terminal group moves to a position where a network condition is poor or a position beyond network coverage, mobility management may not be continuously implemented on the terminal group, which may cause reduction in stability and continuity of mobility management.

In addition, for a single-point failure caused by a server failure, terminal energy exhaustion and the like, a single-point failure referring to a failure of a single unit in a system which causes a failure of the entire system and for which a redundancy measure cannot be taken, there is no effective solution provided in the conventional art, so that continuity of a service is influenced, and Quality of Service (QoS) and user experiences are lowered.

### SUMMARY

In order to solve the existing technical problem, the embodiments of the disclosure provide a mobility management method, device and system and a computer storage medium, which may overcome influence of poor network performance on mobility management of a terminal group and provide a solution to a single-point failure problem, thereby improving QoS.

To this end, the technical solutions of the embodiment of the disclosure are implemented as follows.

An embodiment of the disclosure provides a mobility management method, which may include:

Mobility Management Equipment (MME) acquires service information from a service instruction after receiving the service instruction;

A wireless network accessed by each terminal in a terminal group is determined according to the acquired service information; and

a terminal in the terminal group is invoked to execute a service requested by a user according to the wireless network accessed by each terminal in the terminal group.

In an embodiment, the method may further include: before the step that the wireless network accessed by each terminal in the terminal group is determined, the

MME sends an invoking request to each terminal in the terminal group, finds a terminal of which terminal capability meets a requirement of execution of the service requested by the user according to a response to the invoking request from said terminal, and waits to determine the accessed wireless network.

In an embodiment, the method may further include: before the step that the terminal in the terminal group is invoked to execute the service requested by the user, the MME sends a service issuing instruction to a network server, and receives service data issued by the network server.

In an embodiment, the method may further include: in case of service interruption of the terminal executing the service requested by the user in the terminal group, other terminals in the terminal group are invoked to continue executing the service requested by the user.

In an embodiment, the method may further include that: when currently-operating MME has a single-point failure, a current service and a terminal executing the service requested by the user are switched to backup MME.

In an embodiment, the step that the wireless network accessed by each terminal in the terminal group is determined may include:

matching degrees with current networks are calculated according to the acquired service information;

signal strength and time delay information of each wireless network are collected as acquired parameters;

a decision parameter for network accessing is acquired from the matching degrees and the acquired parameters based on a fuzzy logic theory; and

the wireless network accessed by each terminal is determined according to the decision parameter.

An embodiment of the disclosure further provides a computer storage medium having stored therein computer programs for executing the mobility management method described above.

An embodiment of the disclosure further provides MME comprising a service information acquisition module, a network resource allocation module and a terminal invoking module, in which:

the service information acquisition module may be configured to acquire service information from a service instruction after receiving the service instruction;

the network resource allocation module may be configured to determine a wireless network accessed by each terminal in a terminal group according to the service information acquired by the service information acquisition module; and

the terminal invoking module may be configured to invoke a terminal in the terminal group to execute a service requested by a user according to the wireless network accessed by each terminal in the terminal group, the wireless network accessed by each terminal in the terminal group being determined by the network resource allocation module.

In an embodiment, the service information acquisition module may be further configured to, before the wireless network accessed by each terminal in the terminal group is determined, send an invoking request to each terminal in the terminal group, find a terminal of which terminal capability meets a requirement of execution of the service requested by the user according to a response to the invoking request from said terminal, and wait to determine the accessed wireless network.

In an embodiment, the service information acquisition module may further be configured to, before the terminal in the terminal group is invoked to execute the service requested by the user, send a service issuing instruction to a network server, and receive service data issued by the network server.

In an embodiment, the operation that the network resource allocation module determines the wireless network accessed by each terminal in the terminal group may include that:

matching degrees with current networks are calculated according to the acquired service information;

signal strength and time delay information of each wireless network are collected as acquired parameters;

a decision parameter for network accessing is acquired from the matching degrees and the acquired parameters based on a fuzzy logic theory; and

the wireless network accessed by each terminal is determined according to the decision parameter.

An embodiment of the disclosure further provides a mobility management system comprising working MME, at least one piece of backup MME and at least two terminals, in which:

the working MME may be any MME in the embodiment of the disclosure;

the at least one piece of backup MME may be any MME in the embodiment of the disclosure;

the working MME may further be configured to, when a single-point failure occurs, send a replacement request to the at least one piece of backup MME, and switch a current service and the terminals executing a service requested by a user to the at least one piece of backup MME;

the at least one piece of backup MME may further be configured to return a response to the replacement request after receiving the replacement request from the working MME, acquire execution state information of the service requested by the user after it is determined that the at least one piece of backup MME is, reconfigure a terminal execution environment and network resource of the service requested by the user, and continue executing the service requested by the user; and

the at least two terminals may be configured to execute the service requested by the user after being invoked by the MME.

In an embodiment, when there are multiple pieces of backup MME, the working MME may further be configured to execute an MME selection algorithm to select new MME from the multiple pieces of backup MME.

According to the mobility management method, device and system and computer storage medium provided by the embodiment of the disclosure, the MME is arranged on a terminal side to manage the terminal group; the MME acquires the service information from the service instruction after receiving the service instruction; the wireless network accessed by each terminal in the terminal group is determined according to the acquired service information, and a terminal in the terminal group is invoked to execute the service requested by the user; in such a manner, mutual communication may be implemented through a local area network between terminal groups, constraints resulted from factors such as network signal strength, a coverage area and a network bandwidth may be effectively broken, and interference and influence of network performance on terminal mobility management may be eliminated; and when the terminals frequently join and quit the terminal group, registration signalling is only transmitted in the local area network between the terminal groups, so that occupation of the network bandwidth is effectively reduced, and service data issuing continuity is ensured.

Moreover, by means of installation of the MME on multiple terminals in the terminal group, when one piece of MME has a problem, the other MME may effectively continue executing the service of the user, so that the problem of service interruption caused by a single-point failure resulted from poor network signal, energy exhaustion and the like is effectively solved, service continuity may be remarkably improved, the QoS of the user may be improved, and a service experience of the user may further be improved.

### BRIEF DESCRIPTION OF THE DRAWINGS

FIG. 1 is a topological structure diagram of MME and a terminal group on a terminal side according to an embodiment of the disclosure;

FIG. 2 is an implementation flowchart of a mobility management method according to an embodiment of the disclosure;

FIG. 3 is a flowchart of invoking of a terminal according to a specific embodiment of the disclosure;

FIG. 4 is a flowchart of replacement of MME according to an embodiment of the disclosure;

FIG. 5 is a diagram of an MME selection algorithm according to an embodiment of the disclosure;

FIG. 6 is a structure diagram of MME according to an embodiment of the disclosure; and

FIG. 7 is a structure diagram of a mobility management system according to an embodiment of the disclosure.

### DETAILED DESCRIPTION

In each embodiment of the disclosure: MME is arranged on a terminal side; the

MME acquires service information from a service instruction after receiving the service instruction; and a wireless network accessed by each terminal in a terminal group is determined according to the acquired service information, and a terminal in the terminal group is invoked to execute a service requested by a user.

Here, there may be one or more pieces of MME, and each piece of MME corresponds to a terminal group, is connected with each terminal in the terminal group, and determines a wireless network accessed by each terminal in the terminal group.

Herein, the service instruction at least includes the service information such as the number of services, service type and service priority.

Herein, the step that the terminal in the terminal group is invoked to execute the service requested by the user includes that: one or more terminals of which terminal capabilities meet a requirement of execution of the service requested by the user are found, and the corresponding terminals are invoked to cooperatively work.

The technical solutions of the embodiment of the disclosure are further described in detail below with reference to the drawings and specific embodiments.

In the embodiment of the disclosure, the MME is located on the terminal side, and may be arranged on multiple pieces of terminal equipment in the terminal group, as shown in FIG. 1 which is a topological structure diagram of MME and a terminal group on a terminal side according to an embodiment of the disclosure. In FIG. 1, one end of each of MME 101, MME 102 and MME 103 is connected with a network server, and the other end is connected with multiple terminals respectively, for example: MME 101 is connected with terminal 104, terminal 105 and terminal 106; MME 102 is connected with terminal 107 and terminal 108; MME 103 is connected with terminal 109 and terminal 110; and MME 101, MME 102 and MME 103 are configured to determine the wireless networks accessed by the terminals connected with them respectively.

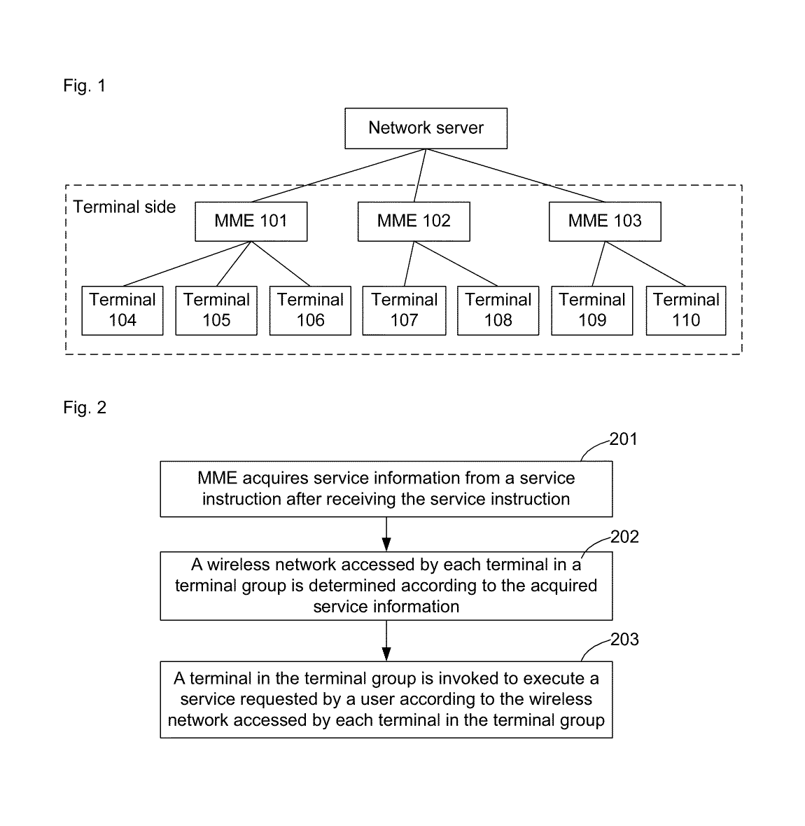

FIG. 2 is an implementation flowchart of a mobility management method according to an embodiment of the disclosure, and as shown in FIG. 2, the mobility management method according to the embodiment of the disclosure includes the following steps:

Step 201, MME acquires service information from a service instruction after receiving the service instruction.

Here, the service instruction is from a network server, and the network server sends the service instruction to the MME on a terminal side after receiving a service request initiated by a user.

Herein, the service information includes, but not limited to, the number of services, service type and service priority.

Step 202, a wireless network accessed by each terminal in a terminal group is determined according to the acquired service information.

Specifically, the MME calculates own matching degrees with current networks by virtue of a network matching degree algorithm in the conventional art according to the service information such as the number of services, the service type and the service priority, collects signal strength and time delay information of each wireless network as acquired parameters, acquires a decision parameter for network accessing from the matching degrees and the acquired parameters based on a fuzzy logic theory, and determines the wireless networks accessed by the terminals according to the decision parameter.

Step 203, a terminal in the terminal group is invoked to execute a service requested by the user.

Here, the MME determines and invokes one or more terminals with adapted terminal capabilities in the terminal group to execute the service requested by the user together according to the received service information such as the service type, the number of services and the service priority.

An embodiment of the disclosure further provides a computer storage medium having stored therein computer programs for executing the mobility management method according to the disclosure.

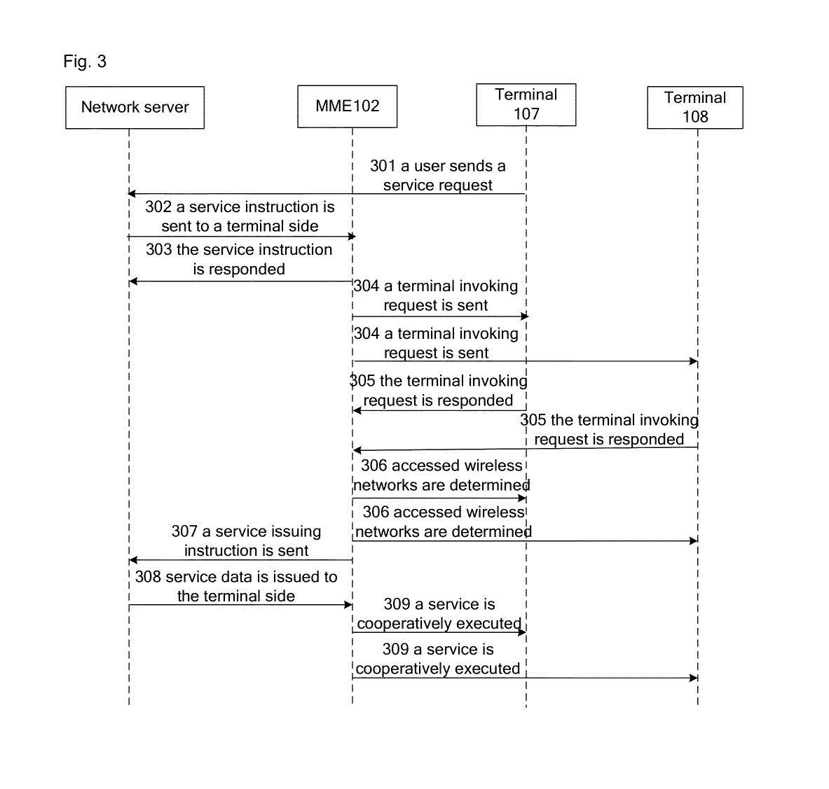

FIG. 3 is a flowchart of invoking of a terminal according to a specific embodiment of the disclosure. In the embodiment, the disclosure is described in detail by taking MME 102 shown in FIG. 1 as an example, and in FIG. 1, MME 102 is connected with terminal 107 and terminal 108. As shown in FIG. 3, the mobility management method for a terminal group in the embodiment includes the following steps:

Step 301, a user initiates a service request to a network server through a terminal used by the user.

Here, the terminal used by the user is terminal 107.

Step 302, the network server sends a service instruction to MME 102.

Here, the network server sends the service instruction to MME 102 on a terminal side after receiving the service request initiated by the user, and the service instruction should include service information such as service type, the number of services and service priority, herein the service type may include a video service, a voice service, a short message service and the like; and the service priority may be high, middle and low.

Step 303, MME 102 responds the service instruction sent by the network server.

Here, MME 102 performs matching of information such as the service type and the service priority after receiving the service instruction sent by the network server, and responds to the service instruction of the network server if the information is successfully matched.

Step 304, MME 102 sends an invoking request to each terminal in the terminal group that is managed by MME 102.

Here, MME 102 sends the service invoking request to all terminals in the terminal group that is managed by MME 102, and in the embodiment, all the terminals include: terminal 107 and terminal 108, that is, the service invoking request is sent to terminal 107 and terminal 108, herein the service invoking request should include the service information such as the service type, the number of services and the service priority, herein the service type may include a video service, a voice service, a short message service and the like; and the service priority may be high, middle and low.

Step 305, a terminal meeting a requirement responds to the terminal invoking request from MME 102.

Here, the terminals receiving the service invoking request decide whether to respond to the invoking request or not according to their own task execution conditions and the acquired service information such as the service type and the service priority, and response information should include capability information of the terminals.

Specific decision criteria are as follows:

(1) it is decided whether the capability of a terminal matches with the service type, if NO, the terminal denies to respond to the invoking request; and if YES, the next step is executed;

(2) it is decided whether the terminal is in a working state, if the terminal is in an idle state, the terminal responds to the invoking request; and if the terminal is in the working state, the next step is executed; and

(3) the priority of a current service of the terminal is compared with the priority of a requested service, the invoking request is responded if the priority of the requested service is higher, and if the priority of the requested service is the same as or lower than that of the current service, the invoking request is denied to be responded.

Step 306, MME 102 determines terminals executing the service requested by the user, and determines accessed wireless networks for the terminals executing the service requested by the user.

Here, MME 102 acquires a capability list of each terminal according to confirmation information returned by the terminals, configures a terminal execution environment of the service, determines accessed wireless networks for each terminal and formulates a shunt transmission strategy for the service.

Here, MME 102 may determine all the terminals that respond to the invoking request as terminals executing the service requested by the user, and may also determine, as required, a part of the terminals that respond to the invoking request as terminals executing the service requested by the user.

A specific manner for allocating wireless network resources may be as follows: the service information such as the service type and the service priority is extracted, and matching degrees with current networks are calculated by virtue of a network matching degree algorithm in the conventional art according to the acquired service information; and parameters such as signal strength and time delays of each wireless network are collected, and these parameters are weighted.

A decision parameter for network accessing is acquired from the matching degrees and the acquired parameters based on a fuzzy logic theory, and the wireless network resources are allocated according to the decision parameter, that is: the wireless network accessed by each terminal is determined. For example: the wireless network accessed by each terminal may be determined on the basis of fuzzy logic and neural network technologies by adopting a particle swarm optimization fuzzy neuron-based network access algorithm.

Specifically, for example, two wireless heterogeneous networks, i.e. a 3-Generation (3G) network and a Wireless Fidelity (WiFi) network, are represented as network 1 and network 2 respectively, C₁ is a signal strength difference between network 1 and network 2, C₂ is a time delay difference between network 1 and network 2, C₃ is a difference of matching degrees of the service type with network 1 and network 2, C₁, C₂ and C₃ are taken as input parameters of a fuzzy neuron, a fuzzy decision factor E may be obtained, and the fuzzy decision factor E meets the following expression:

$$E = Φ {\sum }_{i = 1}^{3} {w}_{i} {C}_{i} ,$$

where Φ is a neuron gain; and Wᵢ is a weighting coefficient corresponding to the input parameter Cᵢ. Network access allocation is implemented according to a value of the fuzzy decision factor E. When E<1, network 1 is accessed; when E>1, network 2 is accessed; and when E=1, the network with a higher network service matching degree is selected for access.

Step 307, MME 102 sends a service issuing instruction to the network server.

Here, after the terminal execution environment of the service is configured, MME 102 sends a service data request message to the network server, and the data request message should include terminal execution environment information of the service.

Step 308, the network server issues service data to the terminal side.

Here, after receiving the service data request message sent from MME 102, the network server sends the service data to each terminal executing the service requested by the user according to the terminal execution environment information in the request message.

Step 309, MME 102 cooperates with each determined terminal to execute the service requested by the user.

In a practical service execution process, a single-point failure caused by energy exhaustion or own failure of a terminal easily occurs, and in case of service interruption caused by damage or energy exhaustion of a certain terminal executing the service requested by the user in the terminal group, the MME may send an invoking request to the other terminals meeting the capability requirement in the terminal group to continue executing the service requested by the user.

Particularly, when a single-point failure occurs to MME, a serious service interruption may occur. Therefore, the embodiment of the disclosure discloses a MME replacement method from the point of ensuring service continuity, and when the MME fails, service continuity may be ensured, and the best service experience may be provided for the user.

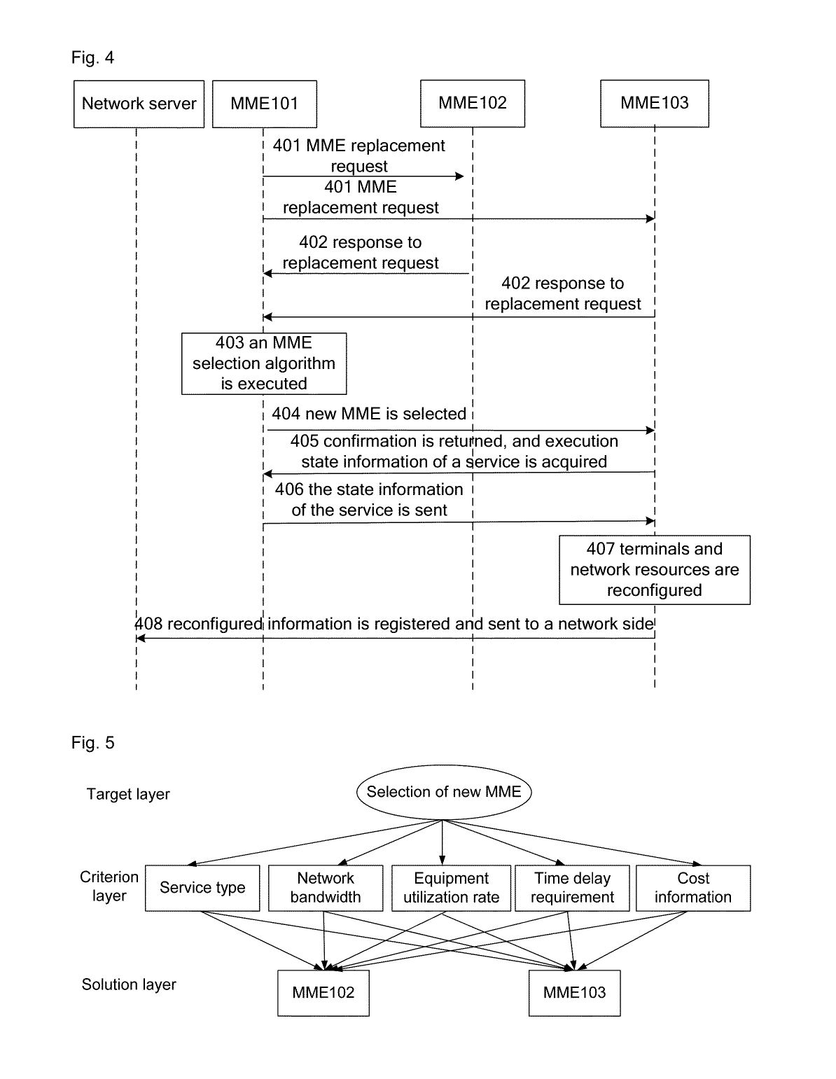

FIG. 4 is a flowchart of replacement of MME according to an embodiment of the disclosure. In the embodiment, the disclosure is further described in detail by taking the condition that MME 101 shown in FIG. 1 is working MME and MME 102 and MME 103 are backup MME as an example. The MME replacement process specifically includes the following steps:

Step 401, MME 101 sends an MME replacement request to MME 102 and MME 103

Here, MME 101 has a single-point failure, triggers the MME replacement process, and sends the replacement request to the other MME in a terminal group.

Triggering conditions for the MME replacement flow include:

(1) when a terminal with MME requires to quit the group due to a factor of space, distance and the like, the replacement process is triggered;

(2) when energy of the MME is lower than a preset threshold, the replacement process is triggered; and

(3) when an index, such as signal strength and a bandwidth, of the MME is lower than a certain threshold and may not meet a service requirement, the replacement process is triggered.

Step 402, MME 102 and MME 103 return responses to the replacement request to MME 101.

Here, MME 102 and MME 103 respond to the replacement request from MME 101 after receiving the MME replacement request, and notify MME 101 to execute the MME replacement process.

Step 403, MME 101 executes an MME selection algorithm.

Here, MME 101 starts executing the MME selection algorithm after receiving the responses, and a specific implementation flow of the MME selection algorithm is shown in FIG. 5.

Step 404, MME 101 selects MME 103 as new MME.

Here, MME 101 selects MME 103 as the new MME after finishing executing the MME selection algorithm, and sends selection information to MME 103 to notify MME 103 that it is selected as the new MME.

Step 405, MME 103 returns confirmation information, and acquires execution state information of a service.

Here, MME 103 returns the confirmation information to MME 101 to agree to replace MME 101 as the new MME to continue executing the service, and simultaneously sends related request information to MME 101 to acquire the execution state information of the related service, the execution state information of the service including: service information such as service type, the number of services and service priority, service data downloading information, terminal execution environment information and the like.

Step 406, MME 101 sends the state information of the service.

Here, MME 101 sends the state information of the service to MME 103 after receiving the confirmation information sent by MME 103, and switches the service and terminals executing the service requested by a user to MME 103.

Step 407, MME 103 reconfigures the terminals and network resources.

Here, MME 103 reconfigures a terminal execution environment and network resources of the service according to the received execution state information of the service.

Step 408, MME 103 registers and sends reconfigured information to a network server.

Here, MME 103 sends the reconfigured terminal execution environment and network resource information of the service to the network server, and performs registration on a network side, and the network server issues the service data according to the received information.

FIG. 5 is a diagram of an MME selection algorithm according to an embodiment of the disclosure. When an MME replacement process is executed, the algorithm is configured to select new MME to implement continuous execution of a service to prevent a condition such as service interruption, and specific algorithm contents are as follows:

MME 101 selects the new MME from MME candidates to implement continuous execution of the service, and the new MME reconfigures a terminal execution environment and network resource of the service, and continues executing the service requested by a user.

In the embodiment of the disclosure, MME 101 selects the new MME from the MME candidates to continue executing the service requested by the user by adopting a hierarchical analysis method, and the target is selection of the new MME; the hierarchical analysis method includes a target layer, a criterion layer and a solution layer; the solution layer includes MME candidates, such as MME 102 and MME 103; the criterion layer includes each reference criterion based on which the new MME is selected, for example: the service type, a network bandwidth, an equipment utilization rate, a time delay requirement and cost information; and the target layer is the selected new MME.

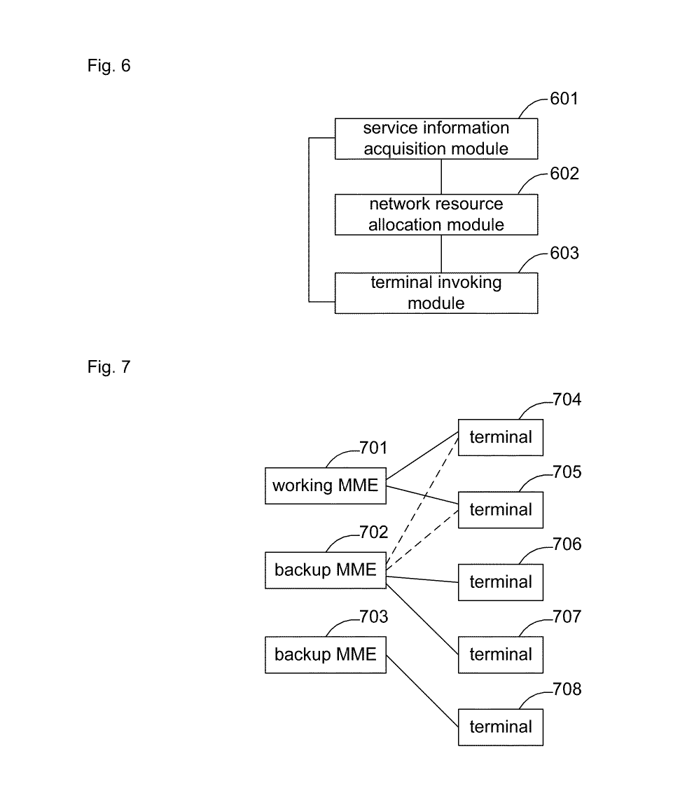

An embodiment of the disclosure further discloses MME, FIG. 6 is a structure diagram of MME according to an embodiment of the disclosure, and as shown in FIG. 6, the MME includes a service information acquisition module 601, a network resource allocation module 602 and a terminal invoking module 603, in which:

the service information acquisition module 601 is configured to acquire service information from a service instruction after receiving the service instruction;

the network resource allocation module 602 is configured to determine a wireless network accessed by each terminal in a terminal group according to the service information acquired by the service information acquisition module 601; and

the terminal invoking module 603 is configured to invoke a terminal in the terminal group to execute a service requested by a user according to the wireless network accessed by each terminal in the terminal group, the wireless network accessed by each terminal in the terminal group being determined by the network resource allocation module 602.

Herein, the service information includes, but not limited to, the number of services, service type and service priority.

Preferably, the service information acquisition module 601 is further configured to, before the wireless network accessed by each terminal in the terminal group is determined, send an invoking request message to each terminal in the terminal group, find a terminal of which terminal capability meets a requirement of execution of the service requested by the user according to a response to the invoking request from said terminal, and wait to determine the accessed wireless network.

Preferably, the service information acquisition module 601 is further configured to, before the terminal in the terminal group is invoked to execute the service requested by the user, send a service issuing instruction to a network server, and receive service data issued by the network server.

Preferably, the service information acquisition module 601 is further configured to monitor an execution condition of the service in a service execution process, and enable cooperation of the other terminals in the group to continue executing the service requested by the user in case of service interruption caused by terminal damage, energy exhaustion and the like.

Specifically, the network resource allocation module 602 calculates matching degrees with current networks by virtue of a network matching degree algorithm in the conventional art according to the acquired service information such as the number of services, the service type and the service priority, collects signal strength and time delay information of each wireless network as acquired parameters, acquires a decision parameter for network accessing from the matching degrees and the acquired parameters based on a fuzzy logic theory, and determines the wireless networks accessed by the terminals according to the decision parameter.

Preferably, the network resource allocation module 602 is further configured to formulate a strategy for selecting and switching between different access points and different networks when the terminals in the group move in a large range among different heterogeneous networks.

Specifically, the network resource allocation module 602 determines the wireless network accessed by each terminal on the basis of fuzzy logic and neural network technologies by adopting a particle swarm optimization fuzzy neuron-based network access algorithm.

Specifically, for example, two wireless heterogeneous networks, i.e. a 3G network and a WiFi network, are represented as network 1 and network 2 respectively, C₁ is a signal strength difference between network 1 and network 2, C₂ is a time delay difference between network 1 and network 2, C₃ is a difference of matching degrees of the service type with network 1 and network 2, C₁, C₂ and C₃ are taken as input parameters of a fuzzy neuron, a fuzzy decision factor E may be obtained, and the fuzzy decision factor E meets the following expression:

$$E = Φ {\sum }_{i = 1}^{3} {w}_{i} {C}_{i} ,$$

where Φ is a neuron gain; and Wᵢ is a weighting coefficient corresponding to the input parameter Cᵢ. Network access allocation is implemented according to a value of the fuzzy decision factor E. When E<1, network 1 is accessed; when E>1, network 2 is accessed; and when E=1, the network with a higher network service matching degree is selected for access.

Here, the MME determines and invokes one or more terminals with adapted terminal capabilities in the terminal group to execute the service requested by the user together according to the received service information such as the service type, the number of services and the service priority.

Specifically, the terminal invoking module 603 is further configured to configure a service execution environment according to received information such as the service type, the number of services, the service priority and a user preference, and replace terminal equipment to implement continuous execution of the service on the premise of ensuring service continuity in case of service interruption caused by terminal damage, energy exhaustion and the like.

Herein, during a practical application, the information acquisition module 601, network resource allocation module 602 and terminal invoking module 603 in the MME may be implemented by a Central Processing Unit (CPU), or Digital Signal Processor (DSP) or Field-Programmable Gate Array (FPGA) in the MME.

The embodiment of the disclosure further discloses a mobility management system, and as shown in FIG. 7, the system includes working MME 701, at least one piece of backup MME such as backup MME 702 and backup MME 703, and at least two terminals such as terminal 704, terminal 705, terminal 706, terminal 707 and terminal 708.

Herein, each piece of MME corresponds to a terminal group, is connected with each terminal in the terminal group, and determines a wireless network accessed by each terminal in the terminal group. For example: the working MME 701 is connected with a terminal 704 and a terminal 705; the backup MME 702 is connected with a terminal 706 and a terminal 707; the backup MME 703 is connected with a terminal 708; and the MME 701, the MME 702 and the MME 703 are configured to determine the wireless networks accessed by the terminals connected therewith.

Herein, the working MME 701, the backup MME 702 and the backup MME 703 may be any structural and functional MME shown in FIG. 6. Specifically, the working MME 701 is configured to acquire service information from a service instruction after receiving the service instruction, determine the wireless network accessed by each terminal and invoke a terminal in a terminal group to execute a service requested by a user.

Herein, the service information includes, but not limited to the number of services, service type and service priority; and

specifically, the MME calculates matching degrees with current networks by virtue of a network matching degree algorithm in the conventional art according to the acquired service information such as the number of services, the service type and the service priority, collects signal strength and time delay information of each wireless network as acquired parameters, acquires a decision parameter for network accessing from the matching degrees and the acquired parameters based on a fuzzy logic theory, and determines the wireless networks accessed by the terminals according to the decision parameter.

Here, the MME determines and invokes one or more terminals with adapted terminal capabilities in the terminal group to execute the service requested by the user together according to the received service information such as the service type, the number of services and the service priority.

The working MME 701 is further configured to send an invoking request to the terminals in the terminal group, find a terminal of which terminal capability meets a requirement of execution of the service requested by the user according to a response to the invoking request from said terminal, and wait to determine the accessed wireless network; send a service issuing instruction to a network server, and receive service data issued by the network server; and monitor an execution condition of the service in a service execution process.

In case of service interruption, caused by damage or energy exhaustion, of a certain terminal executing the service in the terminal group, the working MME 701 may send an invoking request to the other terminals meeting a capability requirement in the terminal group to continue executing the service requested by the user.

Preferably, the working 701 is further configured, when a single-point failure occurs, send a replacement request to the backup MME 702 or the backup MME 703, and switch the current service and the terminals executing the service requested by the user to the backup MME; and

correspondingly, the backup MME 702 or the backup MME 703 is further configured to return a response to the replacement request after receiving the replacement request from the working MME 701, acquire service execution state information after it is determined that it is selected, reconfigure a terminal execution environment and network resource of the service requested by the user, and continue executing the service requested by the user.

When there are multiple pieces of backup MME, the working MME 701 is further configured to execute an MME selection algorithm to select new MME from the multiple pieces of backup MME.

For example, when the single-point failure occurs to the working MME 701, an MME replacement process is triggered, specifically including the following replacement steps:

the working MME 701 sends the replacement request to all the backup MME such as the backup MME 702 and the backup MME 703;

the working MME 701 receives responses to the replacement request from the backup MME 702 and the backup MME 703, and starts the MME selection algorithm to select the backup MME consistent with a condition, such as the backup MME 702, as replacement MME; and

the current service and the terminal 704 and terminal 705 executing the service requested by the user are switched to the backup MME such as the backup MME 702, as shown by a dotted line connection in FIG. 7, to ensure service continuity.

The above are merely preferred embodiments of the disclosure and not intended to limit the scope of protection of the disclosure.

### INDUSTRIAL APPLICABILITY

According to the embodiment of the disclosure, the MME is arranged on the terminal side to manage the terminal group, and the MME acquires the service information from the service instruction after receiving the service instruction; the wireless network accessed by each terminal in the terminal group is determined according to the acquired service information, and a terminal in the terminal group is invoked to execute the service requested by the user; in such a manner, constraints resulted from factors such as network signal strength, a coverage area and a network bandwidth may be effectively broken, interference and influence of network performance on terminal mobility management may be eliminated, and service data issuing continuity is ensured.

What is claimed is:

1. A mobility management method, comprising:
acquiring, by Mobility Management Equipment (MME), service information from a service instruction after receiving the service instruction;
determining a wireless network accessed by each terminal in a terminal group according to the acquired service information; and
invoking a terminal in the terminal group to execute a service requested by a user according to the wireless network accessed by each terminal in the terminal group.

2. The method according to claim 1, further comprising: before determining the wireless network accessed by each terminal in the terminal group, sending, by the MME, an invoking request to each terminal in the terminal group, finding a terminal of which terminal capability meets a requirement of execution of the service requested by the user according to a response to the invoking request from said terminal, and waiting to determine the accessed wireless network.

3. The method according to claim 2, further comprising: before invoking the terminal in the terminal group to execute the service requested by the user, sending, by the MME, a service issuing instruction to a network server, and receiving service data issued by the network server.

4. The method according to claim 1, further comprising: in case of service interruption of the terminal executing the service requested by the user in the terminal group, invoking other terminals in the terminal group to continue executing the service requested by the user.

5. The method according to claim 1, further comprising: when currently-operating MME has a single-point failure, switching a current service and the terminal executing the service requested by the user to backup MME.

6. The method according to claim 1, wherein determining the wireless network accessed by each terminal in the terminal group comprises:
calculating matching degrees with current networks according to the acquired service information;
collecting signal strength and time delay information of each wireless network as acquired parameters;
acquiring a decision parameter for network accessing from the matching degrees and the acquired parameters based on a fuzzy logic theory; and
determining the wireless network accessed by each terminal according to the decision parameter.

7. Mobility Management Equipment (MME), comprising: a service information acquisition module, a network resource allocation module and a terminal invoking module, wherein
the service information acquisition module is configured to acquire service information from a service instruction after receiving the service instruction;
the network resource allocation module is configured to determine a wireless network accessed by each terminal in a terminal group according to the service information acquired by the service information acquisition module; and
the terminal invoking module is configured to invoke a terminal in the terminal group to execute a service requested by a user according to the wireless network accessed by each terminal in the terminal group, the wireless network accessed by each terminal in the terminal group being determined by the network resource allocation module.

8. The MME according to claim 7, wherein the service information acquisition module is further configured to, before the wireless network accessed by each terminal in the terminal group is determined, send an invoking request to each terminal in the terminal group, find a terminal of which terminal capability meets a requirement of execution of the service requested by the user according to a response to the invoking request from said terminal, and wait to determine the accessed wireless network.

9. The MME according to claim 8, wherein the service information acquisition module is further configured to, before the terminal in the terminal group is invoked to execute the service requested by the user, send a service issuing instruction to a network server, and receive service data issued by the network server.

10. The MME according to claim 7, wherein the operation that the network resource allocation module determines the wireless network accessed by each terminal in the terminal group comprises:
calculating matching degrees with current networks according to the acquired service information;
collecting signal strength and time delay information of each wireless network as acquired parameters;
acquiring a decision parameter for network accessing from the matching degrees and the acquired parameters based on a fuzzy logic theory; and
determining the wireless network accessed by each terminal according to the decision parameter.

11. A mobility management system, comprising:
working Mobility Management Equipment (MME), at least one piece of backup MME and at least two terminals, wherein
the working MME is the MME according to claim 7;
the at least one piece of backup MME is the MME according to claim 7;
the working MME is further configured to, when a single-point failure occurs, send a replacement request to the at least one piece of backup MME, and switch a current service and a terminal executing a service requested by a user to the at least one piece of backup MME;
the at least one piece of backup MME is further configured to return a response to the replacement request after receiving the replacement request from the working MME, acquire execution state information of the service requested by the user after it is determined that the at least one piece of backup MME is selected, reconfigure a terminal execution environment and network resource of the service requested by the user, and continue executing the service requested by the user; and
the at least two terminals are configured to execute the service requested by the user after being invoked by the MME.

12. The system according to claim 11, wherein, when there are multiple pieces of backup MME, the working MME is further configured to execute an MME selection algorithm to select new MME from the multiple pieces of backup MME.

13. A computer storage medium having stored therein computer programs for executing a mobility management method, the method comprising:
acquiring, by Mobility Management Equipment (MME), service information from a service instruction after receiving the service instruction;
determining a wireless network accessed by each terminal in a terminal group according to the acquired service information; and
invoking a terminal in the terminal group to execute a service requested by a user according to the wireless network accessed by each terminal in the terminal group.

14. The method according to claim 4, further comprising: when currently-operating MME has a single-point failure, switching a current service and the terminal executing the service requested by the user to backup MME.
